(19) United States
(12) Patent Application Publication
(10) Pub. No.: US 2015/0193855 A1
(43) Pub. Date: Jul. 9, 2015

(54) MODEL HANDSET MODEL CHURN IN A MOBILE NETWORK BY TRACKING UNIQUE SUBSCRIBERS OVER TIME

(71) Applicant: Tektronix, Inc., Beaverton, OR (US)

(72) Inventor: Colm Costelloe, Dublin (IE)

(73) Assignee: Tektronix, Inc., Beaverton, OR (US)

(21) Appl. No.: 14/148,972

(22) Filed: Jan. 7, 2014

(51) Int. Cl. G06Q 30/06; G06Q 30/02

(52) U.S. Cl. CPC G06Q 30/0631; G06Q 30/0255

(57) ABSTRACT

A method for providing a handset recommendation to subscribers in a mobile telecommunication network includes receiving information related to a subscriber's utilization of a handset. A recommended handset for the subscriber is identified based on the subscriber's handset utilization and historical handset migration information. A recommendation is presented to a subscriber.

### FIELD OF THE INVENTION

Embodiments of the present invention relate to a mobile operating environment, and particularly to recommending handsets to subscribers of a mobile service.

### BACKGROUND OF THE INVENTION

Mobile operators or mobile device carriers play a major part in the telecommunication industry today. Initially, such mobile operators concentrated their efforts on generating revenue by increasing their subscriber base. However, it will be appreciated that in several countries, the scope for increasing the subscriber base has now become very limited, as the market has substantially reached a saturation point. As a result, the mobile operators have been branching into providing value added services to subscribers, in order to increase their revenue.

At least some means of generating increased revenue include mobile device upgrades and the sales of premium services to users, such as ringtones, wallpaper, games, and the like. These services may be provided by the mobile operator themselves, or by business entities such as mobile device manufacturers or media brands who may operate in collaboration with the mobile operators or independently, leveraging the carrier's network, to provide such services. The services may be available for download to a mobile device upon payment of a fee.

Many benefits, such as maximizing the potential earnings for sales, accrue upon recommending and promoting mobile devices, content and/or services that are the most likely to be of interest to the users. Further, the user can have a better experience using the user's mobile device in light of these individually recommended devices and services, or independently, leveraging the carrier's network. Thus, recommending mobile devices to subscribers is an important function within sales and customer care centers of a mobile operator.

However, providing helpful suggestions to a user of a mobile device can be thwarted by a lack of information about the user, the user's demographics, likes, and dislikes. Mitigating this issue is made more challenging by the anonymous nature of pre-paid calling plans where registering of subscriber information such as name and address is not required and in the use of family plans where a number of users with different phones may share a single subscription. As another example, a user can make a limited number of purchases or interactions from which to derive recommendations for future transactions. As an additional aspect, soliciting user inputs to improve recommendations can prove tedious or intrusive to some users, who thus would refuse to participate. Currently, mobile device recommendations are typically done using a prescribed list of mobile devices identified as “popular” or “approved” by the mobile operator. However, this approach does not take into account historical information related to a variety of mobile device models.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with a purpose of the illustrated embodiments, in one aspect, a computer-implemented method for providing a handset recommendation to subscribers in a mobile telecommunication network is provided. Information related to a subscriber's utilization of a handset is received and stored. A recommended handset for the subscriber is identified based on the subscriber's handset utilization and historical handset migration information. A recommendation is presented to a user.

In another aspect, a computer program product for providing a handset recommendation to subscribers in a mobile telecommunication network is provided. The computer program product comprises one or more computer-readable storage devices and a plurality of program instructions stored on at least one of the one or more computer-readable storage devices. The plurality of program instructions includes program instructions to receive information related to a subscriber's utilization of a handset. The plurality of program instructions further includes program instructions to identify a recommended handset for the subscriber based on the subscriber's handset utilization.

### BRIEF DESCRIPTION OF THE DRAWINGS

The accompanying appendices and/or drawings illustrate various, non-limiting, examples, inventive aspects in accordance with the present disclosure:

FIG. 1 illustrates an example communication network in accordance with an illustrated embodiment;

FIG. 2 is a flow diagram of operational steps of the customer care manager program of FIG. 1 in accordance with an illustrative embodiment of the present invention;

FIG. 3A depicts exemplary data structures for storing a correlation between a handset and a subscriber and for storing a number of subscribers associated with each handset in accordance with an embodiment of the present invention;

FIG. 3B illustrates an exemplary directed graph of handset migrations that may be generated by the customer care manager (CCM) program of FIG. 1 in accordance with an embodiment of the present invention;

FIGS. 4A and 4B illustrate a specific example illustrating generation of a directed graph based on historical subscriber/handset correlation information in accordance with an embodiment of the present invention;

FIGS. 5A and 5B are exemplary graphical representations of information related to generated recommendations that may be presented to a user by the customer care manager program of FIG. 1 in accordance with an illustrative embodiment of the present invention; and

FIG. 6 illustrates internal and external components of server computer of FIG. 1 in accordance with an illustrative embodiment of the present invention.

### DETAILED DESCRIPTION OF CERTAIN EMBODIMENTS

The present invention is now described more fully with reference to the accompanying drawings, in which illustrated embodiments of the present invention is shown wherein like reference numerals identify like elements. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims.

As used herein, the term “subscriber” refers to a user of a mobile handset device, also referred to as user equipment (UE), for communicating in the mobile telecommunications network.

A telecommunications network is a geographically distributed collection of nodes interconnected by communication links and segments for transporting data between end nodes, such as smart phones, pads, personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Various embodiments of the present invention will now be described, by way of example only, and with reference to Global System for Mobile Communications (GSM) Enhanced Data rates for GSM Evolution (EDGE) network architecture.

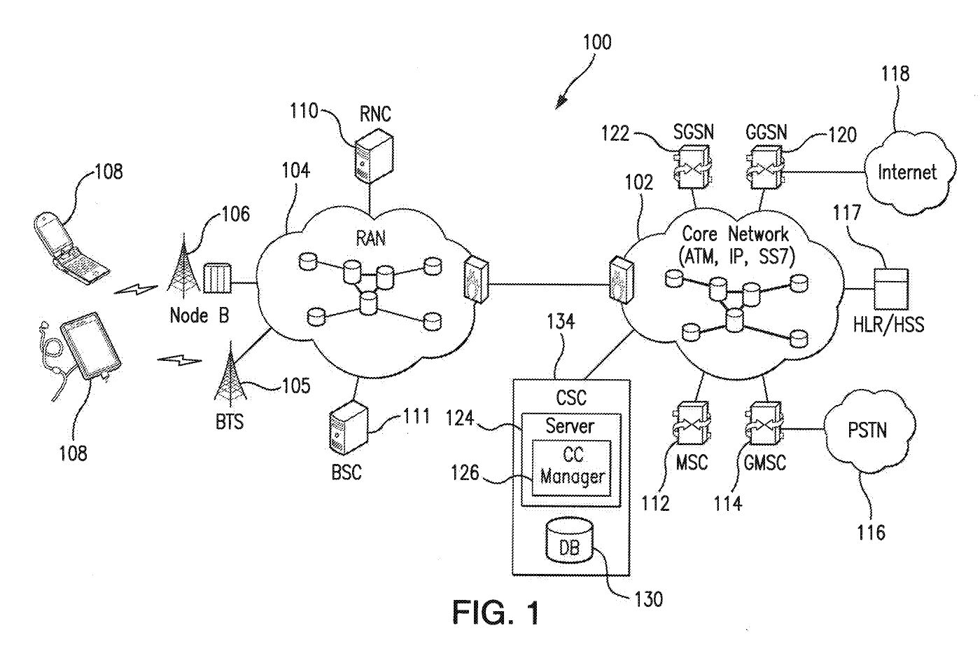

FIG. 1 is a high level diagram of an example mobile telecommunications network 100, in which an embodiment of the present invention may be implemented. The mobile telecommunications network 100 architecture includes a core network 102 interconnected with a Radio Access Network (RAN) 104 via an interface known as IU which is defined in detail in the current publicly available 3GPP (Third Generation Partnership Project) specification documents. In the exemplary environment illustrated in FIG. 1, the radio part 104 of the mobile telecommunications network 100 comprises one or more GERANs (GSM/EDGE Radio Access Network), coupled with one or more UTRANs (Universal Terrestrial Radio Access Networks) which is a part of a Universal Mobile Telecommunications System (UMTS). The standards for GERAN and UTRAN are maintained by the 3GPP. It is to be further appreciated that the foregoing configuration is purely illustrative, and various implementations may include other cellular technologies, such as, WCDMA (Wideband Code Division Multiple Access), CDMA2000, CDMA 1x EVDO, LTE-A (Long Term Evolution-Advanced), and the like in various combinations.

The RAN 104 is configured to provide wireless telecommunication services to subscribers through UEs 108 via a radio interface known as UU. The UMTS part of the RAN 104 has base stations, known as NodeBs 106, while the GSM part has base stations known as BTSs (Base Transceiver Stations) in 3GPP, which collectively provide for the geographic coverage for wireless communications with UEs 108. In the UMTS part of RAN 104, groups of one or more NodeBs 106 are connected to a Radio Network Controller (RNC) 110 via an interface known as Iub in 3GPP. The RAN 104 may have several groups of NodeBs 106 connected to different RNCs 110, only one of which is shown in the example depicted in FIG. 1. Where more than one RNCs 110 are provided in a RAN 104, inter-RNC 110 communications is preferably performed via the Iub interface. In the GSM part of RAN 104, groups of one or more BTSs 105 are connected to a Base Station Controller (BSC) 111. A BSC 111 controls a group of BTSs 105 connected to it via the A-bis interface. It is noted, while the embodiments are described herein with reference to a combined UMTS/GSM network architecture, the description herein is not so limited, and may be applied to a variety of networks and interfaces.

UEs 108 typically have a home network (HN) with which it is registered and through which billing and other functions are processed. Under current 3GPP specifications, the core network 102 of a UE's 108 HN serves to coordinate and process the functions of Authentication, Authorization and Accounting (AAA functions). When a UE 108 travels beyond its HN, the HN's core network 102 facilitates the UE's 108 use of a Foreign Network (FN) by being able to coordinate the AAA functions so that the FN will permit the UE 108 to conduct communications. To assist in implementing this activity, the core network 104 includes a Home Location Register (HLR) 117 which tracks the UEs 108 for which it is the HN. A Home Service Server (HSS) is provided in conjunction with the HLR 117 to process the AAA functions.

Under current 3GPP specifications, the core network 102, and preferably not the RAN 104, is configured with connectivity to external systems such as Public Land Mobile Networks (PLMN), Public Switch Telephone Networks (PSTN) 116, Integrated Services Digital Network (ISDN) and other Real Time (RT) services via an RT service interface. Core network 102 will also support Non-Real Time (NRT) services with the Internet 118. Under current 3GPP specifications, the core network 102 provides RT service external connectivity via a Gateway Mobile Switching Center (GMSC) 114. The core network 102 preferably provides NRT service, known as General Packet Radio Service (GPRS), external connectivity via a Gateway GPRS Support Node (GGSN) 120. In this context, a particular NRT service may actually appear to a subscriber to be a real time communication due to the communication speed and associated buffering of the Time Division Duplex (TDD) data packets forming the communication. One example of this is voice communication via the Internet 118 which can appear to the subscriber as a normal telephone call conducted by a switching network, but is actually being conducted using an Internet Protocol (IP) connection which provides packet data service.

To provide support for both RT and NRT services from external sources for radio linked UEs 108 in a 3GPP system, the RAN 104 typically needs to interface with the CN 102, which is the function of the Iu interface. To enable this communication, the core network 102 typically includes a Mobile Switching Center (MSC) 112 that is coupled to the GMSC 114 and a Serving GPRS Support Node (SGSN) 122 that is coupled to the GGSN 120.

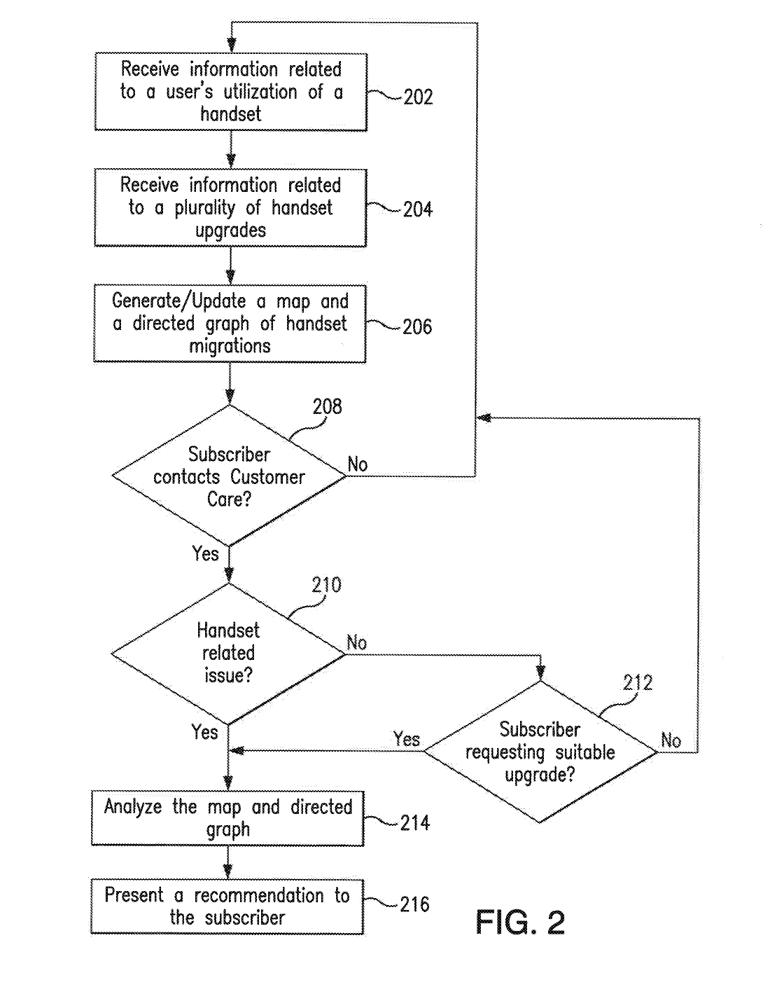

Customer experience management is an important operational scheme for service providers. Thus, service providers typically maintain a customer service/call center to provide support to the users of handsets 108 and/or to monitor the network 100, such as Customer Service Center (CSC) 134 depicted in FIG. 1. According to an embodiment of the present invention, CSC 134 may include a variety of customer service systems. One of the customer service systems may include, but not limited to a server 124 which may be communicatively connected to the core network 102. In an embodiment of the present invention, server 124 may comprise, or otherwise may cooperate with a customer care manager (CCM) software program 126. CCM 126 may be, for example, a computer program or program component capable of collecting certain information about each mobile subscriber and configured to provide a recommendation to subscribers interested in purchasing and/or upgrading their handheld device, based on the collected information. Currently, in the context of recommending a handheld mobile device to a new or existing subscriber mobile operator's customer care representatives typically use a predetermined list of handsets that are considered popular or “approved” by the mobile operator. However, the aforementioned recommendations fail to take into account other important factors, such as, for example, subscriber's historical usage information, quality of experience information, and the like. In other words these recommendations of an appropriate device to a subscriber are not based on actual services and/or quality of services that the subscriber uses. Advantageously, CCM 126 is preferably configured to obtain and store historical information, such as subscriber/handset correlation, and to generate information indicative of most common handsets the subscribers are moving to and from, as described below in conjunction with FIG. 2. Furthermore, in a preferred embodiment, CCM 126 combines such data with subscriber's service experience and utilization information to provide a crowd-sourced tailored set of recommendations for a particular subscriber. Data gathered, generated, and maintained for use by the CCM 126 may be kept in the internal storage of the server 124 or in one or more databases 130 of the CSC 134.

Those skilled in the art will understand that any number of nodes, devices, links, etc. may be used in the computer network, and that the view shown in FIG. 1 is for simplicity. Also, while the embodiments are shown herein with reference to combined UMTS/GSM network architecture, the description herein is not so limited, and may be applied to a variety of networks such as LTE (4g), WCDMA, CDMA2000, CDMA 1x EVDO and the like. For purposes of the present patent application, the RAN 104 may be implemented in any combination of known or heretofore unknown radio access technology and network protocols. The RAN 104 can also be an aggregation of channels from multiple bands in the radio access technology LTE-A. LTE-A is a set of enhancements to the UMTS that includes an all-IP networking architecture and the ability of each NodeB to connect to multiple core networks.

FIG. 2 is a flow diagram of operational steps of the customer care manager program of FIG. 1 in accordance with an illustrative embodiment of the present invention. CCM 126 may be, for example, a computer program or program component capable of collecting certain information about each mobile subscriber and configured to provide a recommendation to subscribers interested in purchasing and/or upgrading their handheld device, based on the collected information. In an embodiment of the present invention, CCM 126 preferably utilizes a plurality of passive probing data sources to obtain information related to a plurality of handheld devices used by the plurality of subscribers. CCM 126 preferably stores collected and generated information in a plurality of data structures, as described below.

At 202, CCM 126 preferably collects information related to each subscriber's utilization of a corresponding handset using a plurality of passive probing data sources. The plurality of data sources may include, but not limited to, subscriber records, call data records, SMS data records, user-plane related function information (e.g., API calls). The subscriber record typically holds information such as International Mobile Subscriber Identity (IMSI), Mobile Station International ISDN Number (MSISDN) and subscriber key. Whenever UEs 108 make or receive a call for example in a UMTS radio network, signaling messages are exchanged between Node Bs 106 and RNCs 110 over Iub interfaces and, for some calls, between RNCs 110 over Iur interfaces. RNCs 110 and Node Bs 106 make up the UTRAN portion of a UMTS/GSM network 100. Accordingly, a monitor or probe (not shown in FIG. 1) may be coupled to Iub, Iur and Iu-CS interfaces in the UTRAN. With regards to a GSM portion of the UMTS/GSM network 100 a monitor or probe may be coupled to A interface, through which signaling messages are exchanged between MSC 112 and BSC 111. Also, while the embodiments are shown herein with reference to combined UMTS/GSM network 100 architecture, the description herein is not so limited, and may be applied to a variety of networks such as LTE (4g), IMS, and the like. Monitoring probes implemented in LTE network may connect to, for example, a voice over long term evolution (VoLTE) interface, while in IMS environment, monitoring probes may be coupled to SIP based IMS interface. Monitoring probes non-intrusively coupled to one of the above mentioned interfaces preferably capture substantially all of the protocol messages traveling across these interfaces. In addition monitoring equipment may identify the messages belonging to each voice or data call and may correlate those messages into one call record per call, one SMS record per SMS message, and so on.

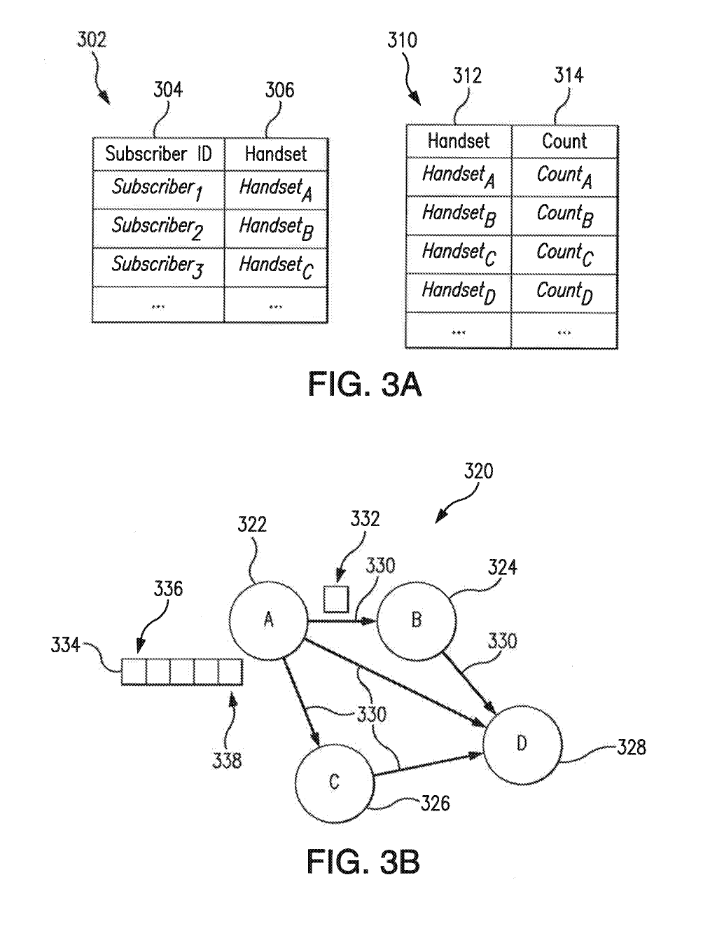

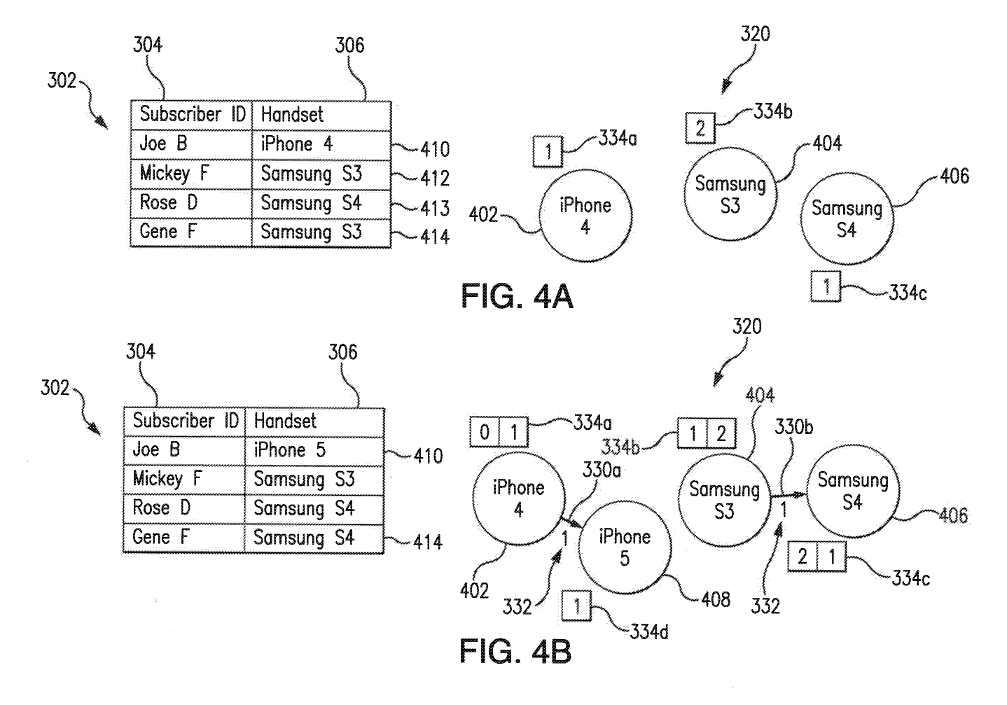

At 204, CCM 126 preferably receives information related to a plurality of handset upgrades. In an embodiment of the present invention CSC 134 may retain subscribers' information when upgrading handsets. Information related to handset upgrades may comprise subscriber identification information, models of handheld devices the subscribers migrate from/to over time, software and firmware installed on the respective models, and the like. Handheld migration related data for use by the CCM 126 may be kept in the internal storage of the server 124 or in one or more databases 130 of the CSC 134. As will be appreciated by one skilled in the art, various embodiments of the present invention contemplate that CCM 126 may maintain and utilize collected information related to mobile subscribers' handheld device usage and upgrades in order to recommend an appropriate device for a subscriber. In one embodiment, this information may be represented by a directed graph and a map indicative of corresponding subscriber/handset correlations. At 206, CCM 126 may generate and/or update a map and a directed graph, as described below in conjunction with FIGS. 3A, 3B, 4A and 4B.

FIG. 3A depicts exemplary data structures for storing a correlation between a handset and a subscriber and for storing a number of subscribers associated with each handset in accordance with an embodiment of the present invention. CCM 126 may process a plurality of service data records (such as subscriber records, call transaction records, SMS data records, user-plane API calls) to identify the relationship between subscribers and handset devices. CCM 126 may store these relationships in a data structure such as a map. While the embodiments are shown herein with reference to a map, it should be apparent that a variety of data structures such as, for example, objects, arrays, linked lists, or trees can be used instead. Data structures may be stored in database 130 of the CSC 134 or any other computer-readable storage medium accessible to the CCM 126.

A map of subscriber to handset data structure 302 shown in FIG. 3A may have a Subscriber ID 304 and a Handset value 306. The Subscriber ID 304 may be a unique value associated with a subscriber or an account. Next, there may be a handset value 306. The handset value 306 may indicate the type (i.e., the model and manufacturer) of the handset associated with the corresponding subscriber or an account. It is noted that additional fields may be included in the map of subscriber to handset data structure 302. For example, map data structure 302 may contain information related to subscriber's profile (i.e., billing type) to further improve the prediction of the most appropriate handset.

According to an embodiment of the present invention, in addition to keeping track of correlations between subscribers and handsets, for each handset value 306 stored in the map data structure 302 CCM 126 preferably computes each day the number of unique subscribers that utilized each handset during the day. Accordingly, CCM 126 may maintain the number of subscribers data structure 310 shown in FIG. 3A which may have a handset value field 312 and a count value field 314. The handset value field 312 in the number of subscribers data structure 310 preferably contains a distinct record for each unique handset value 306 stored in the map data structure 302. The count value field 314 in the number of subscribers data structure 310 preferably contains a number of unique subscribers that utilized the corresponding handset. It is noted that additional fields may be included in the number of subscribers data structure 310 as well.

FIG. 3B depicts an exemplary directed graph 320 representing handset migrations that may be generated by the CCM program 126 of FIG. 1 in accordance with an embodiment of the present invention. In FIG. 3B, each of a plurality of nodes 322-328 represents specific handset values 312 stored in the above mentioned data structures. Furthermore, each of a plurality of edges 330 represents a migration of one or more subscribers from one particular handset type to another. Edges 330 have a direction associated with them. As a non-limiting example, exemplary directed graph 320 graphically illustrates that during a pre-determined period of time one or more subscribers (represented in FIG. 3B by element 332) have migrated from handset type A 322 to handset type B 324. Similarly, at least one subscriber has migrated from each of handset type A 322, type B 324 and handset type C 326 to handset type D 328 and so forth. In addition, the exemplary directed graph 320 may include unique subscriber count information, such as information stored in the number of subscribers data structure 310, for each of the plurality of nodes 322-328. For instance, element 334 may represent an array of unique subscriber count values associated with the handset type A 322 for a predetermined period of N days. In the array 334, first record 336 may represent the most resent count value stored, for example, in the number of subscribers data structure 310, while the last record 338 may represent a corresponding value for day N. According to an embodiment of the present information, CCM 126 may generate directed graph 320 presented in FIG. 3B using information collected via various interfaces described above.

FIGS. 4A and 4B illustrate a specific example of how a directed graph may be generated based on historical subscriber/handset correlation information in accordance with an embodiment of the present invention. More specifically, FIG. 4A depicts an exemplary map data structure 302 comprising two fields Subscriber ID 304 and a Handset value 306 described above in conjunction with FIG. 3A. The first record 410 in the map data structure 302 indicates a correlation between the subscriber Joe B and iPhone 4®. The iPhone 4® is a smartphone developed by Apple Inc. The second record 412 in the map data structure 302 indicates a correlation between the subscriber Mickey F and Samsung S3®. The Samsung S3® is a smartphone developed by Samsung Electronics Co., Ltd. The last record 414 correlates subscriber Gene F with the Samsung S3® type of handset. It should be noted that for clarity and ease of illustration the map data structure 302 contains only few records. However, in actual CSC 134 environment additional entries for additional subscriber ID values may be present in the map of subscriber to handset data structure 302.

Furthermore, FIG. 4A depicts an exemplary directed handset migrations graph 320 which may be generated by CCM 126 based, at least in part, on the information contained in the map data structure 302. For instance, the first node 402 of graph 320 represents the first record 410 of the map data structure 302, the second node 404 represents the second 412 and last 414 records of the map data structure 302, and the third node 406 represents the third record 413. According to an embodiment of the present invention, in addition to depicting a plurality of distinct handset types (nodes 402-406) the exemplary handset migrations graph 320 may also contain information indicative of number of unique subscribers associated with each of the plurality of handset types. This information is represented in graph 320 by elements 334 a-c. It is noted that since Samsung S3® type appears twice in the map data structure 302, the counter value 334b associated with the second node 404 representing the aforementioned handset type is equal to 2. It is further noted that the map data structure 302 shows an exemplary data for one day only. Therefore, at this point in time CCM 126 just generates an original handset migrations graph 320 without any edges, because CCM 126 has not detected any migrations yet.

FIG. 4B depicts an exemplary map data structure 302 that stores data collected during the following day. In other words, if the map data structure 302 of FIG. 4A stores, for instance, July 8th data, the map data structure 302 of FIG. 4B stores data for July 9th. It is noted that handset values 306 for the first record 410 and the last record 414 of the map data structure 302 of FIG. 4B have changed. More specifically, the first record 410 and the last record 414 of the map data structure 302 of FIG. 4B indicate, respectively, that subscriber Joe B is now associated with iPhone 5® (developed by Apple Inc.), while subscriber Gene F is now associated with Samsung S4® (developed by Samsung Electronics Co., Ltd).

According to an embodiment of the present invention, in response to detecting these changes in corresponding subscriber/handset correlations, CCM 126 may update the handset migrations graph 320 accordingly. The handset migrations graph 320 of FIG. 4B represents cumulative data. For instance, since the first record 410 of the map data structure 302 of FIG. 4B contains a new handset type, iPhone 5®, not present in the previous version of the map data structure 302 (shown in FIG. 4A), CCM 126 preferably generates a fourth node 408 corresponding to the aforementioned handset type. In addition, the updated handset migrations graph 320 illustrates migration from iPhone 4® to iPhone 5® models, represented by edge 330a, and migration from Samsung S3® to Samsung S4® models, represented by edge 330b. Edges 330 a-b have a direction associated with them, the direction originating at the node representing the old handset type and terminating at the node representing the new handset type. According to an embodiment of the present invention, the updated graph 320 may also show the number of migrations 332 between particular types of handsets as well as the number of unique subscribers 334 a-d associated with each of the plurality of handset types. It is noted that elements 334 a-d may maintain data corresponding to each of the days for the period under consideration. For instance, element 334a associated with the first node 402 shows counter values for both data contained in the map data structure 302 of FIG. 4A and data contained in the map data structure 302 of FIG. 4B.

Referring back to FIG. 2, subsequent to collecting original set of information related to each subscriber's utilization of a corresponding handset using a plurality of passive probing data sources (step 202) CCM 126 may generate a migrations graph (step 206), such as migrations graph 320 shown in FIG. 4A, based on the collected data. As data related to subscribers' utilization of corresponding handsets changes over time, CCM 126 may reflect those changes by updating the graph (step 206) accordingly, for instance, as shown in FIG. 4B. According to an embodiment of the present invention, CCM 126 optionally may repeat the steps 202-206 above iteratively (step 208, no branch) until one of the plurality of subscribers (e.g., first subscriber) contacts the CSC 134 to report an issue. This contact may be handled, for example, by a mobile operator's customer care representative, or the like.

In response to detected first subscriber's contact (step 208, yes branch), CCM 126 preferably determines whether the reported issue relates to the first subscriber's handset at step 210. In an embodiment of the present invention, CCM 126 may make the determination, for example, by prompting the customer care representative (e.g., via a graphical user interface (GUI)) to ask the first subscriber a set of predetermined questions. In various embodiments of the present invention, the GUI (not shown in FIG. 1) may be configured to run on server 124 or the remote client device (not shown in FIG. 1) connected to the server 124. In an alternative embodiment, at 210, CCM 126 may automatically determine whether the issue reported by the first subscriber is related the first subscriber's handset by verifying that the reported problems correlate strongly to the overall handset service experience and may compare first subscriber's experience to the experience of all subscribers of the specific handset to determine whether first subscriber's handset performs worse than similar devices.

If CCM 126 determines that the reported issue does not relate to the first subscriber's handset (step 210, no branch), CCM 126 may next determine whether the first subscriber is interested in upgrading the device, at step 212. In response to determining that the first subscriber is not interested in the upgrade (step 212, no branch), CCM 126 may iteratively repeat steps 202-206 until next subscriber (e.g., second subscriber) contacts the CSC 134. However, in response to determining that the issue reported by the first subscriber is related to the corresponding handset (step 210, yes branch) or in response to determining that the first subscriber is interested in the upgrade (step 212, yes branch), at step 214, CCM 126 may analyze the information contained in the directed graph of handset migrations (such as directed graph 320 shown in FIG. 4A) and/or may analyze information contained in one or more data structures (i.e., map data structure 302 of FIG. 4B) generated/updated at step 206. According to an embodiment of the present invention, CCM 126 may identify the node corresponding to the first subscriber's handset and may traverse one or more edges originating at that node to identify, for example, one or more handsets (represented by the terminating nodes) that other subscribers (who previously used the subscriber's handset) have migrated to. In an embodiment of the present invention, CCM 126 may refine the resultant data, for instance, by specific services (i.e., SMS, MMS, and the like) the first subscriber is using and/or by a first subscriber's profile (i.e., pre-paid, post-paid, corporate, VIP, and the like). In yet another embodiment, CCM 126 may identify a list of handsets to recommend based on the subscriber's upgrade eligibility, for instance, based on handset prices. Once the analysis described above is complete, according to an embodiment of the present invention, CCM 126 may present a recommendation for a replacement handset to the subscriber, at step 216.

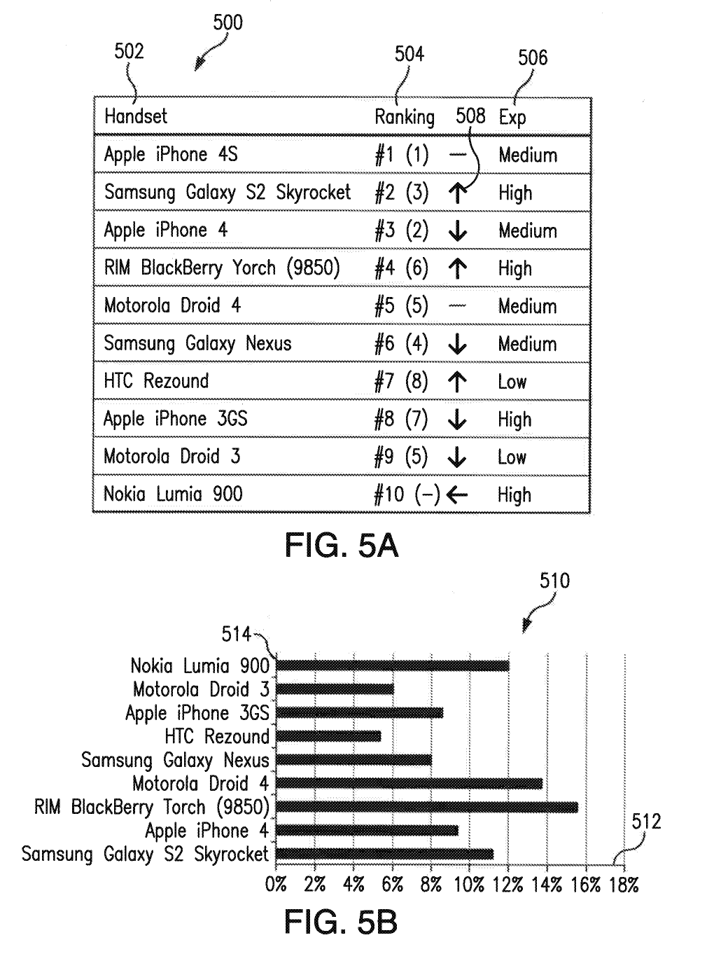

In one embodiment of the present invention, CCM 126 may present the generated recommendation for a replacement handset, for example, via the GUI discussed above. For instance, the GUI may be configured to display the list of most appropriate options received from the CCM 126. FIG. 5A illustrates an exemplary display 500 of recommended replacement handset models sorted, for example, by a subscriber count. The display 500 shown in FIG. 5A may include three fields: handset 502, ranking 504 and experience 506. The handset field 502 may display a list of recommended options identified by CCM 126. The ranking field 504 may present numeric rankings associated with each of the options in the handset field 502. In an embodiment of the present invention, the handset having the highest number of subscribers associated with it may be ranked first, while the handset having the lowest number of subscribers associated with it may be ranked last. In addition to current ranking values, the ranking field 504 may include one or more visual indicators indicative of latest popularity trend. For instance, an upward pointing arrow 508 shown in FIG. 5A may indicate that the popularity of corresponding handset is increasing. This trend may be determined by CCM 126 by evaluating whether the number of unique subscribers has increased for a given service during the predetermined period of time. On the other hand, if CCM 126 determines that there are fewer unique subscribers for a given service and a given handset, the display 500 may show a downward pointing arrow in the ranking field 504, next to the current ranking. The downward arrow would indicate that corresponding handset is declining in popularity. The experience field 506 may present information related to overlay service experience. For example, in one implementation, the measure of overlay service experience may be abstracted as high, medium or low. The user of the exemplary display 500 (i.e. customer service representative) may utilize information presented in the experience field 506, for example, to advice against devices that have inferior quality for services that the subscriber typically uses.

According to an embodiment of the present invention, in addition to current ranking and quality of recommended handsets, the CCM 126 (via GUI) may present information related to handset migration. FIG. 5B illustrates a horizontal bar chart 510 that is formed in accordance with an embodiment of the invention. The exemplary horizontal bar chart 510 depicts information related to subscribers migration towards the most popular handset model shown in FIG. 5A (Apple iPhone 4S®). The horizontal bar chart 510 may be constructed having a first axis 514 representing handset models and a second axis 512 representing a percentage of subscribers that migrated towards Apple iPhone 4S® from a corresponding handset model. For instance, FIG. 5B illustrates that approximately 16% of the subscribers currently using iPhone 4S® handset previously used RIM BlackBerry Torch® (manufactured by Research in Motion Limited) and approximately 5% previously used HTC Rezound (developed by HTC Corp.).

In summary, CCM 126 monitors the usage of various handsets supported by a mobile operator. In addition, CCM 126 keeps track of subscribers' migration between the various handsets. In accordance with various embodiments of the present invention, CCM 126 is configured to analyze collected crowd sourced data and provide a recommendation for a replacement handset based on the analyzed crowd sourced data.

The flowchart and block diagram in the FIG. 2 illustrates the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

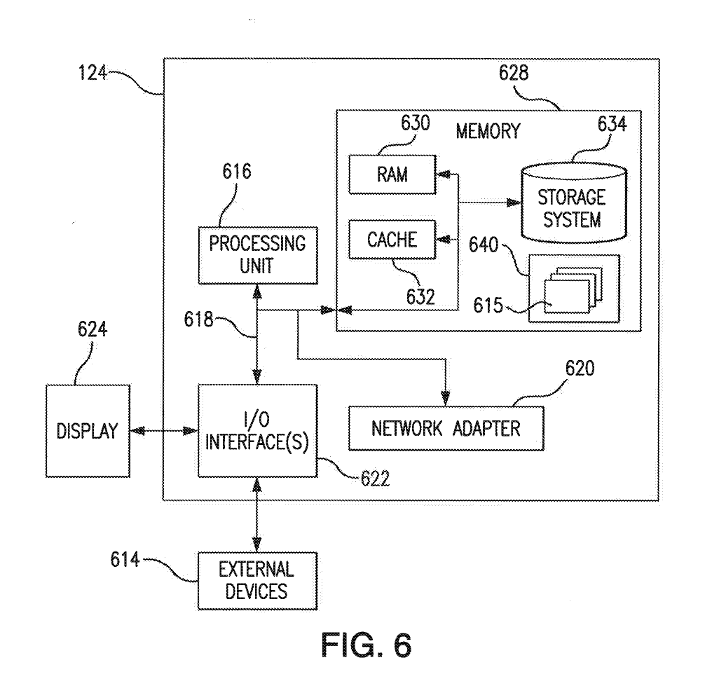

FIG. 6 is a schematic block diagram of an example server 124 that may be used (or components thereof) with one or more embodiments described herein. The server 124 is only an example of a suitable server computer and is not intended to suggest any limitation as to the scope of use or functionality of embodiments of the invention described herein. Regardless, the server 124 is capable of being implemented and/or performing any of the functionality set forth hereinabove.

Server 124 is operational with numerous other general purpose or special purpose computing system environments or configurations. Examples of well-known computing systems, environments, and/or configurations that may be suitable for use with server 124 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices, and the like.

Server 124 may be described in the general context of computer system-executable instructions, such as program modules, being executed by a computer system. Generally, program modules may include routines, programs, objects, components, logic, data structures, and so on that perform particular tasks or implement particular abstract data types. Server 124 may be practiced in distributed data processing environments where tasks are performed by remote processing devices that are linked through the telecommunication network 100. In a distributed data processing environment, program modules may be located in both local and remote computer system storage media including memory storage devices.

Server 124 is shown in FIG. 6 in the form of a general-purpose computing device. The components of server 124 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Server 124 typically includes a variety of computer system readable media. Such media may be any available media that is accessible by server 124, and it includes both volatile and non-volatile media, removable and non-removable media.

System memory 628 can include computer system readable media in the form of volatile memory, such as random access memory (RAM) 630 and/or cache memory 632. Server 124 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 615, such as CCM module 126 described above, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 615 generally carry out the functions and/or methodologies of embodiments of the invention as described herein.

Server 124 may also communicate with one or more external devices 614 such as a keyboard, a pointing device, a display 624, etc.; one or more devices that enable a user to interact with server 124; and/or any devices (e.g., network card, modem, etc.) that enable server 124 to communicate with one or more other computing devices. Such communication can occur via Input/Output (I/O) interfaces 622. Still yet, server 124 can communicate with one or more networks such as a local area network (LAN), a general wide area network (WAN), and/or a public network (e.g., the Internet) via network adapter 620. As depicted, network adapter 620 communicates with the other components of server 124 via bus 618. It should be understood that although not shown, other hardware and/or software components could be used in conjunction with server 124. Examples, include, but are not limited to: microcode, device drivers, redundant processing units, external disk drive arrays, RAID systems, tape drives, and data archival storage systems, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for providing a handset recommendation to subscribers in a mobile telecommunication network, the method comprising the steps of:
receiving information related to a subscriber's utilization of a handset;
receiving information related to handset upgrades; and
identifying a recommended handset for the subscriber based on the subscriber's handset utilization in view of the received information relating to handset upgrades.

2. The computer-implemented method of claim 1, wherein the information related to the subscriber's handset utilization includes at least subscriber's record information, subscriber's call record information, short message service (SMS) information, multimedia messaging service (MMS), and user plane related function information.

3. The computer-implemented method of claim 1, wherein each upgrade identifies an origin handset and a resultant handset, and wherein the upgrade relates to replacing the origin handset with the resultant handset and wherein the step of identifying a recommended handset is further based on the information related to the plurality of handset upgrades.

4. The computer-implemented method of claim 3, wherein the plurality of handset upgrades was performed by a plurality of subscribers, the method further comprising:
receiving information related to handset usage by a first subscriber;
receiving information related to handset usage by the plurality of subscribers;
comparing the handset usage by the plurality of subscribers to the first subscriber's handset utilization; and
wherein the step of identifying a recommended handset is further based on the comparison.

5. The computer-implemented method of claim 4 further comprising identifying correlations between a plurality of handsets and the plurality of subscribers, in response to receiving information related to the plurality of handset upgrades.

6. The computer-implemented method of claim 4 further comprising:
generating a directed graph representing the plurality of handset upgrades; and
wherein the step of identifying a recommended handset is further based on the directed graph.

7. The computer-implemented method of claim 6, wherein the step of identifying a recommended handset is further based on the subscriber's upgrade eligibility.

8. A computer program product for providing a handset recommendation to subscribers in a mobile telecommunication network, the computer program product comprising:
one or more computer-readable storage devices and a plurality of program instructions stored on at least one of the one or more computer-readable storage devices, the plurality of program instructions comprising:
program instructions to receive information related to a subscriber's utilization of a handset;
program instructions to receive information related to handset upgrades; and
program instructions to identify a recommended handset for the subscriber based on the subscriber's handset utilization in view of the received information relating to handset upgrades.

9. The computer program product of claim 8, wherein the information related to the subscriber's handset utilization includes at least subscriber's record information, subscriber's call record information, short message service (SMS) information, multimedia messaging service (MMS), and user plane related function information.

10. The computer program product of claim 8 wherein each upgrade identifies an origin handset and a resultant handset, and wherein the upgrade relates to replacing the origin handset with the resultant handset and wherein the program instructions to identify a recommended handset further include the information related to the plurality of handset upgrades.

11. The computer program product of claim 10, wherein the plurality of handset upgrades was performed by a plurality of subscribers, the computer program product further comprising:
program instructions to receive information related to handset usage by a first subscriber;
program instructions to receive information related to handset usage by the plurality of subscribers;
program instructions to compare the handset usage by the plurality of subscribers to the first subscriber's handset utilization; and
wherein the program instructions to identify a recommended handset are based on the comparison.

12. The computer program product of claim 11, further comprising program instructions to identify correlations between a plurality of handsets and the plurality of subscribers, in response to receiving information related to the plurality of handset upgrades.

13. The computer program product of claim 11, further comprising:
program instructions to generate a directed graph representing the plurality of handset upgrades; and
wherein the program instructions to identify a recommended handset are further based on the directed graph.

14. The computer program product of claim 13, wherein the program instructions to identify a recommended handset are further based on the subscriber's upgrade eligibility.

15. A computer system for providing a handset recommendation to subscribers in a mobile telecommunication network, the computer system comprising one or more processors, one or more computer-readable storage devices, and a plurality of program instructions stored on at least one of the one or more storage devices for execution by at least one of the one or more processors, the plurality of program instructions comprising:
program instructions to receive information related to a subscriber's utilization of a handset;
program instructions to receive information related to handset upgrades; and
program instructions to identify a recommended handset for the subscriber based on the subscriber's handset utilization in view of the received information relating to handset upgrades.

16. The computer system of claim 15, wherein the information related to the subscriber's handset utilization includes at least subscriber's record information, subscriber's call record information, short message service (SMS) information, multimedia messaging service (MMS), and user plane related function information.

17. The computer system of claim 15 wherein each upgrade identifies an origin handset and a resultant handset, and wherein the upgrade relates to replacing the origin handset with the resultant handset and wherein the program instructions to identify a recommended handset further include the information related to the plurality of handset upgrades.

18. The computer system of claim 17, wherein the plurality of handset upgrades was performed by a plurality of subscribers, the computer program product further comprising:
program instructions to receive information related to handset usage by a first subscriber;
program instructions to receive information related to handset usage by the plurality of subscribers;
program instructions to compare the handset usage by the plurality of subscribers to the first subscriber's handset utilization; and
wherein the program instructions to identify a recommended handset are based on the comparison.

19. The computer system of claim 18, further comprising program instructions to identify correlations between a plurality of handsets and the plurality of subscribers, in response to receiving information related to the plurality of handset upgrades.

20. The computer system of claim 18, further comprising:
program instructions to generate a directed graph representing the plurality of handset upgrades; and
wherein the program instructions to identify a recommended handset are further based on the directed graph.
